(19) United States
(12) Patent Application Publication
(10) Pub. No.: US 2022/0166277 A1
(43) Pub. Date: May 26, 2022

(54) STATOR WITH WIRE GUIDING INSULATOR

(71) Applicant: NIDEC Motors & Actuators (Germany) GmbH, Bietigheim-Bissingen (DE)

(72) Inventors: Kosuke Ogawa, Stuttgart (DE); Tomoyuki Umeda, Stuttgart (DE)

(21) Appl. No.: 17/534,685

(22) Filed: Nov. 24, 2021

(30) Foreign Application Priority Data
Nov. 26, 2020 (DE) 102020131417.5

(51) Int. Cl. H02K 3/34; H02K 3/52; H02K 3/28

(52) U.S. Cl. CPC H02K 3/345; H02K 2203/06; H02K 3/28; H02K 3/522

(57) ABSTRACT

A stator includes a rotationally symmetrical stator core with stator teeth, each of which is at least partially surrounded by an insulator which includes a winding chamber with a winding space, the winding space being bounded on an inner side by an inner flange and on the outer side by an outer flange. The stator includes coils wound around the insulators in the winding space, the windings of which coils include a winding wire including a first winding wire end portion on one side of the winding wire and a second winding wire end portion on another side of the winding wire. The outer flange of the insulator includes two recesses on its inner side at the end surface, into each of which recesses one of the two winding wire end sections is inserted and fixed.

### CROSS REFERENCE TO RELATED APPLICATION

The present application claims priority under 35 U.S.C. § 119 to German Application No. 10 2020 131 417.5, filed on Nov. 26, 2020, the entire contents of which are hereby incorporated herein by reference.

### 1. FIELD OF THE INVENTION

The present disclosure relates to a stator, as well as to a brushless electric motor having such a stator and to a method of winding a stator tooth of a stator of a brushless electric motor.

### 2. BACKGROUND

A brushless electric motor as a three-phase electric machine has a stator with a number of stator teeth arranged, for example, in a star shape, each of which is enclosed by an insulator around which an electric stator winding is wound in each case. In conventional windings, the wire ends usually extend to the left and right at the outer end of the stator tooth. This has the disadvantage that the wire ends are always close to those of the neighboring tooth. The coils are associated with the coil ends of individual strands and are interconnected in a predetermined manner by common connecting conductors. In the case of a brushless electric motor as a three-phase machine, the stator has three strands and thus at least three connecting conductors to which electric current is applied in a phase-shifted manner in each case in order to generate a rotating magnetic field in which a rotor or armature, which is usually provided with permanent magnets, rotates. The connecting conductors are fed to a motor electronics unit to control the electric motor. The coils of the stator winding are interconnected in a certain way by means of the connecting conductors. The type of interconnection is determined by the winding scheme of the stator winding, whereby a star connection or a delta connection of the coils is usual as a winding scheme.

It is known to use the connecting conductors in the form of a busbar assembly. The busbar assembly includes busbars which are connected with their end sections on one side to the winding wires of the coil groups respectively and on the other side each have an external connection terminal for electrical connection to a control unit.

### SUMMARY

Example embodiments of the present disclosure provide stators each being simple to manufacture, able to be automated, and including a structure that facilitates the construction of a busbar assembly.

Example embodiments of the present disclosure also provide stators, electric motors with stators, and methods of winding stator teeth of stators of brushless electric motors.

An example embodiment of the present invention includes a stator with a rotationally symmetrical stator core including stator teeth each at least partially surrounded by an insulator including a winding chamber with a winding space, the winding space being bounded on an inner side by an inner flange and on an outer side by an outer flange. The stator includes coils wound around the insulators in the winding chamber, the windings of which include a winding wire including a first winding wire end portion on one side of the winding wire and a second winding wire end portion on the other side of the winding wire. The outer flange of the insulator includes two recesses on its inner side at the end surface, into each of which recesses one of the two winding wire end sections is inserted and fixed, the recesses extending from the end surface of the insulator with their longitudinal axes parallel to the longitudinal axis of the stator, and a first of the two recesses being located centrally of the stator tooth in the circumferential direction with respect to the longitudinal axis of the stator, and a second of the two recesses being located in a lateral end region of the outer flange in the circumferential direction.

The longitudinal axis of the stator corresponds to the axis of symmetry and central axis as well as the axis of rotation of the rotor of the electric motor in which the stator is mountable. Furthermore, with respect to the central axis or the longitudinal axis, a radial direction is referred to, which indicates the distance from the central axis, and a circumferential direction is referred to, which is distinguished tangentially to a certain radius extending in the radial direction.

Since, according to an example embodiment of the present disclosure, both end portions of the winding wire are held and positioned in the insulator, a busbar assembly can be easily contacted therewith. In addition, the winding is prevented from getting slack. In addition, the distance between the two winding wire end portions is particularly large in the circumferential direction, which has advantages for contacting.

Preferably, each stator tooth includes an elongated tooth body and a tooth root adjoining it at one radial end and a tooth tip adjoining it at another radial end. The insulator surrounds the tooth body and at least partially surrounds the tooth tip and the tooth root. The recesses extend with their longitudinal axes parallel to the longitudinal axis of the stator from the surface of the insulator to a height corresponding approximately to the top of the tooth body. The recesses are thus long enough to securely receive the winding wire end portions. It is advantageous if the recesses are approximately circular in cross-section with an opening for insertion of the wire, and the wire is clipped or pressed into the recesses to provide a secure positive attachment.

In an example embodiment of the present disclosure, a first one of the two winding wire end portions is inserted into the first recess and the tooth body is wound away from the second recess in a radial direction from the outside to the inside and back from the inside to the outside, with a second one of the two winding wire end portions inserted into the second recess.

Preferably, the lateral end of the outer flange adjacent to the second recess defines a radially inwardly projecting projection adjacent to the underside of the recess, which projection defines the winding space in the circumferential direction of the second winding wire end portion and thus secures the position of the second winding wire end portion during the winding process.

In order to improve contacting with a busbar assembly, it is advantageous if the winding wire ends of the winding wire end sections of each stator tooth protrude over the insulator at the end surface (top). The winding wire ends preferably extend in the longitudinal direction (parallel to the longitudinal axis of the stator) in the area of the recesses.

It is preferred that the distance between the two winding wire ends of a stator tooth in the circumferential direction is at least about 40% of the total width of the outer flange in the circumferential direction. In particular, the spacing is selected such that the spacing of consecutive winding wire ends of the stator in the circumferential direction is constant or substantially constant.

Furthermore, an electric motor including a rotor which is mounted rotatably about an axis of rotation is provided, the rotor being surrounded externally by a previously described stator. Preferably, the winding wire ends are electrically contacted at the end surface with a busbar assembly, the contacts of which are evenly spaced in the circumferential direction. Such a busbar assembly is particularly easy to manufacture and can be automatically placed on the stator.

In addition, a method of winding a stator tooth of a stator of a brushless electric motor is provided. The stator tooth is at least partially surrounded by an insulator which includes a winding chamber with a winding space, the winding space being bounded on an inner side by an inner flange and on the outer side by an outer flange. The outer flange of the insulator includes two recesses on its inner side, which recesses extend with their longitudinal axes parallel to the longitudinal axis of the stator from the end surface of the insulator, and a first of the two recesses is located centrally of the stator tooth in the circumferential direction with respect to a central axis of the stator, and a second of the two recesses is located in a lateral end region of the outer flange lying in the circumferential direction. The method includes inserting and fixing a first winding wire end portion of a winding wire into the first recess, guiding the winding wire away from the second recess and around the insulator to define a winding direction, wrapping of the stator tooth in radial direction from the outside to the inside and back from the inside to the outside while maintaining the winding direction, and inserting and fixing a second winding wire end portion of the winding wire opposite to the first winding wire end portion into the second recess.

The winding process is particularly simple and can be automated due to the defined positions of the winding wire end sections.

Preferably, the lateral end of the outer flange adjacent to the underside of the recess defines a projection projecting inwardly in the radial direction, past which the winding wire is guided internally in the wrapping, so that the projection defines the outward position of the second winding wire end portion to carry out the inserting and fixing, and prevents the second winding wire end portion from slipping outwardly. For further preferred features of the stator tooth, please refer to the preceding description of the stator.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 is a top view of a stator tooth with insulator according to an example embodiment of the present disclosure.

FIG. 2 is a spatial view of a stator tooth with a first winding wire end inserted according to an example embodiment of the present disclosure.

FIG. 3 is a spatial view of the wound stator tooth with first and second winding wire ends.

FIG. 4 is a spatial view of the wound stator tooth with first and second winding wire ends inserted.

FIG. 5 is a top view of the wound stator tooth in the final state.

FIG. 6 is a spatial view of a stator including a plurality of stator teeth and a bus bar assembly according to an example embodiment of the present disclosure.

### DETAILED DESCRIPTION

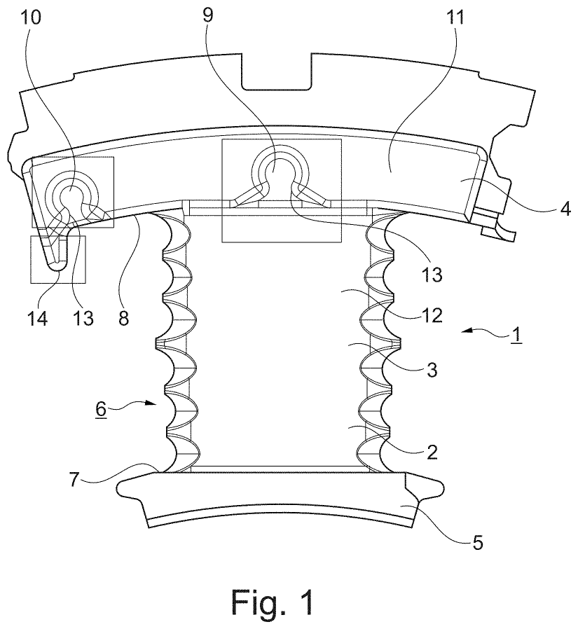

FIG. 1 shows a stator tooth 1 with an insulator 2 which insulates the winding, which is not shown, from the stator tooth 1. Each stator tooth 1 has an elongate tooth body 3 and a tooth root 4 adjoining it at one radial end and a tooth tip 5 adjoining it at the other end. The tooth root 4 is wider than the tooth head 5 in the circumferential direction with respect to the longitudinal axis of the stator, and is on the outside in the radial direction. The insulator 2 surrounds the tooth body 3, the tooth head 5, as well as parts of the tooth base 4. The insulator 2 has a winding chamber 6 in each case, which is wound by a winding wire not shown. The winding chamber 6 has a winding space which, in the radial direction with respect to the longitudinal axis of the stator, is bounded on the inside by an inner flange 7 and on the outside by an outer flange 8. The outer flange 8 has two recesses 9, 10 at the top of the end surface on the inner side, which are provided for guiding and fixing the winding wire end sections which are not shown. The recesses 9, 10 only project into the outer flange from the inner side and do not penetrate it. The recesses 9,10 extend with their longitudinal axes parallel to the longitudinal axis of the stator from the end surface of the insulator 11 to a height corresponding approximately to the top face of the tooth body 12. The recesses 9,10 are approximately circular in cross-section with an opening 13 for insertion of the wire. A first of the two recesses 9 is located centrally of the tooth body 3 in the circumferential direction with respect to the longitudinal axis of the stator. In other words, the first recess 9 lies on a plane of symmetry of the stator tooth 1. The second recess 10 lies in the axial direction at the same level as the first recess 9. In the circumferential direction, the second recess 10 lies in an end region of the tooth root. In the case illustrated, the second recess 10 is located to the left of the first recess 9 in a plan view of the inner side of the outer flange 8. The left end of the outer flange 8, which delimits the second recess 10 on the left side, forms a projection 14 projecting inwards in the radial direction adjacent to the underside of the recess 10 at a height of the tooth body. This projection 14 serves to guide the wire during the winding process.

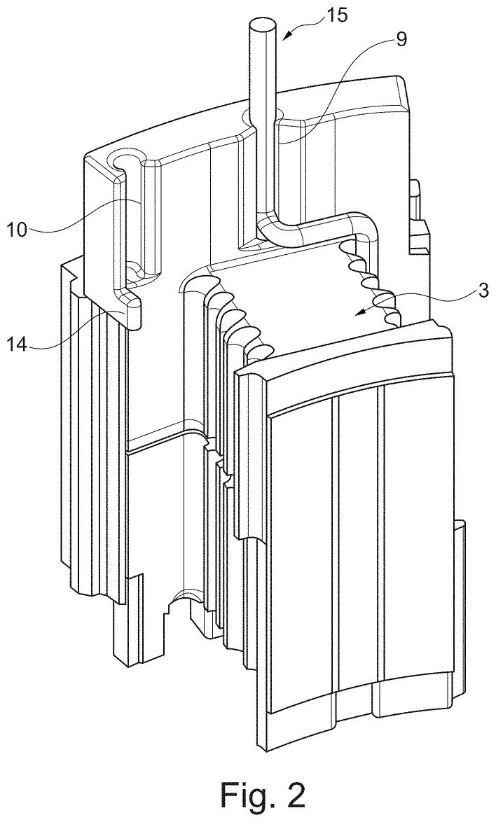

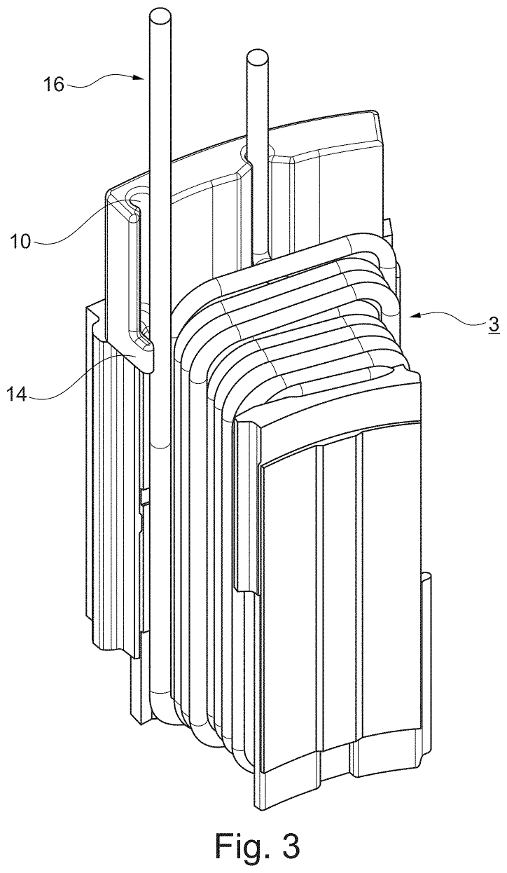

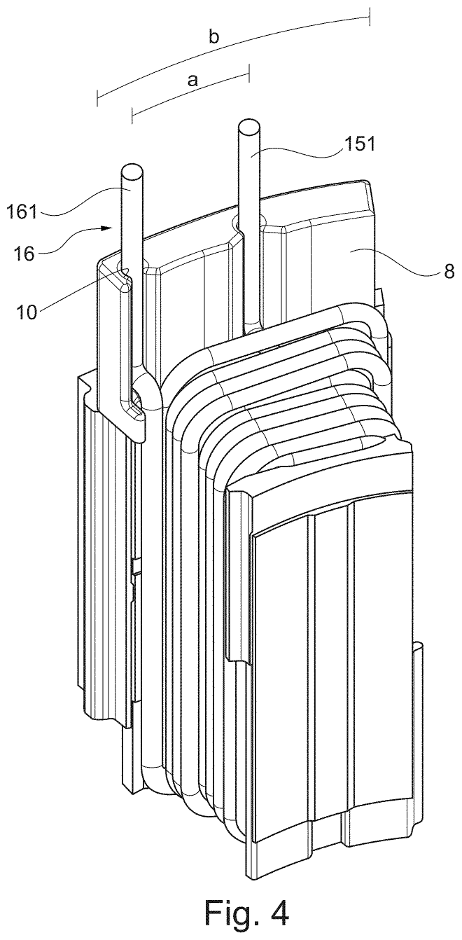

FIG. 2 shows a three-dimensional view of the position of the projection 14. A first winding wire end portion 15 is inserted or clipped into the first recess 9. The first winding wire end portion 15 extends in the region of the first recess 9 parallel to the longitudinal axis of the stator and is then guided clockwise, away from the second recess 10, around the tooth body 3. Winding is performed in the radial direction from the outside to the inside and back from the inside to the outside until the condition shown in FIG. 3 is reached. A second winding wire end portion 16 of the same wire is located on the outside left of the tooth body 3 at the end of the winding process. The projection 14 of the tooth root limits the position of the second winding wire end portion 16 laterally to the left and prevents the winding wire from slipping. In a final step, the second winding wire end portion 16 is pressed radially outward into the second recess 10 and fixed in position there, as shown in FIG. 4. The second winding wire end portion 16 thus also extends parallel to the longitudinal axis of the stator in the region of the second recess 10. The winding wire ends 151, 161 of the winding wire end sections 15, 16 project in the longitudinal direction of the stator at the top from the end surface of the outer flange of the insulator 8. The distance a between the two winding wire ends in the circumferential direction is at least 40% of the total width of the outer flange b in the circumferential direction. In this case, the outer flange 8 has approximately the width of the tooth root 4.

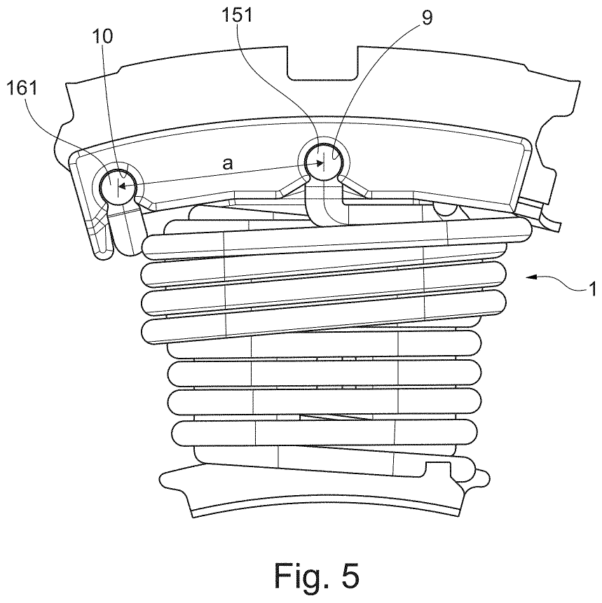

FIG. 5 shows a top view of the stator tooth 1 in the final state of the winding process. The winding wire ends 151, 161 are at a fixed distance a from each other. The distance to the ends of the adjacent teeth, which are not shown, corresponds approximately to this distance a. The distance between the contacts in the circumferential direction of the stator is thus constant, which considerably simplifies the assembly of a busbar assembly, in particular the welding process. Moreover, since the wire ends are positively held in the recesses 9,10, in particular clipped or pressed in, the position of the ends 151,161 is clearly defined for the assembly and the winding cannot get any play.

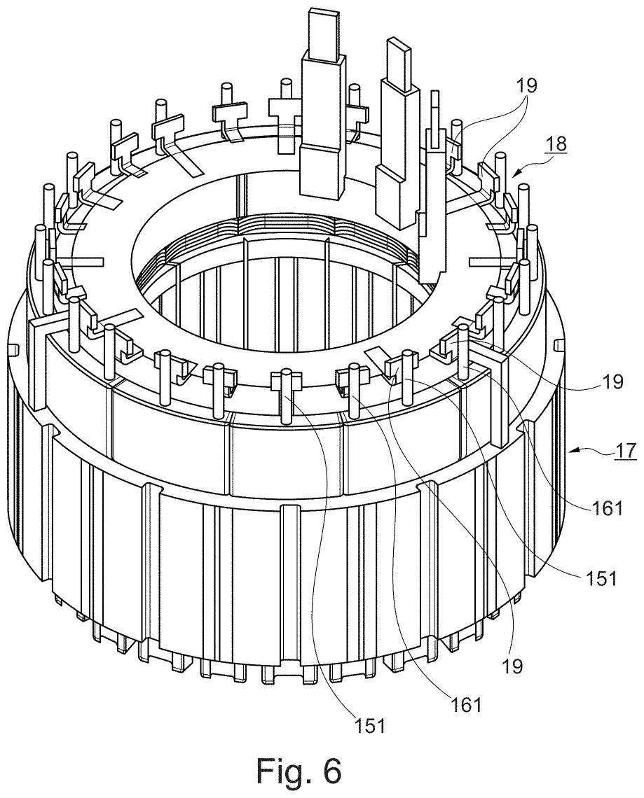

FIG. 6 shows an arrangement of a stator 17 with a busbar assembly 18 mounted on the top. The contacts of the busbar assembly 19 are all evenly spaced in the circumferential direction. Contacting with the winding wire ends 151,161 has not yet taken place in the example shown. In a next process, the winding wire ends 151,161 are welded to the contacts of the busbar assembly 19 in a fully automated manner, this is possible due to the spacing and position of the winding wire ends 151,161 on a common side of the stator. The exact positioning of the winding wire ends also ensures that they are aligned parallel to the longitudinal axis and are firmly in a defined position, which greatly simplifies assembly.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator comprising:
a rotationally symmetrical stator core with stator teeth;
an insulator that at least partially surrounds each of the stator teeth, the insulator including a winding chamber with a winding space, the winding space being bounded on an inner side by an inner flange and on an outer side by an outer flange; and
coils wound around the insulators in the winding space, the windings of which coils including a winding wire including a first winding wire end portion on one side of the winding wire and a second winding wire end portion on another side of the winding wire; wherein
the outer flange of the insulator includes two recesses on an inner side at an end surface, into each of which one of the two winding wire end sections are inserted and fixed;
the recesses extend with their longitudinal axes parallel to a longitudinal axis of the stator from a front surface of the insulator; and
a first of the two recesses is located centrally of one of the stator teeth in a circumferential direction to a central axis of the stator and a second of the two recesses is located in a lateral end region of the outer flange in the circumferential direction.

2. The stator according to claim 1, wherein
each of the stator teeth includes an elongated tooth body and a tooth root at one radial end, and a tooth head at another radial end;
the insulator surrounds the tooth body and at least partially surrounds the tooth head and the tooth root; and
the recesses extend with their longitudinal axes parallel to the longitudinal axis of the stator from the front surface of the insulator to a height which approximately corresponds to a height of the upper side of the tooth body.

3. The stator according to claim 1, wherein
the recesses are approximately circular in cross-section with an opening to permit insertion of the winding wire; and
the winding wire is clipped into a corresponding one of the recesses.

4. The stator according to claim 1, wherein
a first of the two winding wire end sections is inserted in the first recess, and the tooth body is wound around on an outside away from the second recess and in a radial direction from the outside to an inside and back from the inside to the outside, and a second of the two winding wire end sections is inserted in the second recess.

5. The stator according claim 1, wherein the lateral end of the outer flange adjacent to the second recess and adjacent to a bottom of the recess defines a projection projecting inwardly in the radial direction, which limits the winding space in the circumferential direction of the second winding wire end section.

6. The stator according to claim 1, wherein the two winding wire end sections of each of the stator teeth include a winding wire end which projects upwards beyond the insulator at the end surface.

7. The stator according to claim 1, wherein a distance between the two winding wire ends in the circumferential direction is at least about 40% of a total width of the outer flange in the circumferential direction.

8. The stator according to claim 1, wherein a distance between circumferentially successive winding wire ends of the stator is constant.

9. An electric motor, comprising
a rotor mounted to rotate about an axis of rotation; and
a stator according to claim 1 surrounding the rotor externally.

10. The electric motor according to claim 9, wherein the winding wire ends are electrically contacted at the end surface with a busbar assembly, the contacts of which are uniformly spaced in the circumferential direction.

11. A method of winding a stator tooth of a stator of a brushless electric motor, the stator tooth being at least partially surrounded by an insulator which includes a winding chamber with a winding space, the winding space being bounded on an inner side by an inner flange and on an outer side by an outer flange, wherein the outer flange of the insulator includes two recesses at a front surface of an inner side, which extend with their longitudinal axes parallel to the longitudinal axis of the stator tooth from the front surface of the insulator, and a first of the two recesses is located in a circumferential direction to the longitudinal axis of the stator tooth centrally of the stator tooth and a second of the two recesses is located in a circumferential lateral end region of the outer flange, the method comprising:
a) inserting and fixing a first winding wire end portion of a winding wire into the first recess;
b) leading the winding wire away from the second recess and around the insulator, resulting in a winding direction;
c) wrapping the stator tooth in the direction from the outer flange to the inner flange and back while maintaining the winding direction; and
d) inserting and fixing a second winding wire end portion of the winding wire opposite the first winding wire end portion into the second recess.

12. The method according to claim 11, wherein the lateral end of the outer flange adjacent to the second recess defines a projection adjacent to an underside of the recess and projecting inwardly in a direction of the inner flange, which projection is passed internally in step c) so that the projection defines a position of the second winding wire end portion outwardly to perform step d).
